(19) United States
(12) Patent Application Publication
(10) Pub. No.: US 2005/0018422 A1
(43) Pub. Date: Jan. 27, 2005

(54) Light diffusing device

(76) Inventor: Peter Rutkowski, Stamford, CT (US)

Correspondence Address: ST. ONGE STEWARD JOHNSTON & REENS, LLC, 986 BEDFORD STREET, STAMFORD, CT, 06905-5619, US

(21) Appl. No.: 10/626,679

(22) Filed: Jul. 24, 2003

(51) Int. Cl. F21V 21/092

(52) U.S. Cl. 362/208; 362/355; 362/397

(57) ABSTRACT

A light diffusing device comprising a light source with an emission section, a translucent suction cup with a first side and a second side, the first side attached to the lamp emission section and a diffusion element attached to the second side of the translucent suction cup, the diffusion element radiating the lamp light out in a plurality of directions. A diffuser for diffusing a radiation source, the diffuser comprising a translucent body with a suction cup attachment end and a diffuser end, the suction cup end positioning the diffuser in a path of radiation source radiation and the diffuser end diffusing the radiation source radiation that travels through the translucent body into a plurality of directions.

### FIELD OF THE INVENTION

The present invention relates to a light-diffusing device that redirects a directional light emitted from a light source to a diffused light radiating in multi-directions.

### BACKGROUND OF THE INVENTION

Lighting devices come in many different shapes and forms in order to accomplish many different tasks. For example, a flashlight provides a primarily directional beam while a floodlight provides diffused lighting over a larger area. There are also devices that attempt to combine the ability to perform multiple lighting tasks into a single device such as a modified flashlight in which the beam can be adjusted from a narrow directional light into a broad directional light.

The result of attempts to create a single device providing both directional and diffused area lighting has produced devices that are heavy, outsized for the task and complicated. For instance, when backpacking, weight and size are of paramount concern and therefore carrying two lighting devices is not feasible nor is the use of a heavy and complicated multiple use lighting device or attachment. Other fields of endeavor or activities that share similar resource constraints are maritime, aviation, emergency services and the like.

Consequently, what is need is an assembly that can convert a directional light into a diffused area light without adding much weight, size and/or complexity. Thus, what is needed is a lightweight, compact and simple device to convert directional lighting into diffused area lighting.

### SUMMARY OF THE INVENTION

Accordingly, it is an object of the present invention to provide a lightweight, compact and simple device to convert directional lighting into diffused area lighting.

Another object to the present invention is to provide a device that can inexpensively modify directional lighting into area lighting.

A further object of the present invention is to provide a device that can be used as a signal or emergency beacon.

A further object of the present invention is to provide a device that has multiple diffusion elements that are quickly and easily interchanged.

These and other objects of the present invention are achieved by provision of a lamp assembly comprising a lamp with an emission section, a translucent suction cup with a first side and a second side, the first side attached to the lamp emission section and a diffusion element attached to the second side of the translucent suction cup, the diffusion element radiating the lamp light out in a plurality of directions. The lamp assembly can contain a diffusion element, which is colored and/or is made of a thermoplastic.

Preferably, the device also includes a light-diffusing device that adapts directional light into area lighting, the light diffusing device comprising a lamp or light source with an emission section and a connection section, the lamp providing a light source, a hollow housing with an emission end and a connection end inside the hollow housing, the connection section of the lamp or light source connected to the connection end of the housing and the emission section of the lamp surrounded by the housing, a transparent medium with an exterior face and an edge, the edge attaching the transparent medium to the emission end of the housing, a translucent suction cup with a first side and a second side, the first side attached to the exterior face of the transparent medium and a diffusion element attached to the second side of the translucent suction cup, the diffusion element radiating the light source out in a plurality of directions. The light-diffusing device can contain a diffusion element, which is colored and/or is made of a thermoplastic.

Preferably, the present invention also includes a directional light adaptor kit for use with a directional light source comprising a translucent suction cup with a first side and a second side, the first side selectively and removably attachable to the directional light source and a diffusion element on the second side of the translucent suction cup, the diffusion element radiating the directional light source light out in a plurality of directions. The directional light adaptor kit for use with a directional light source can contain multiple diffusion elements, which are colored and/or made of thermoplastic that are easily and quickly interchanged.

Preferably, the present invention also includes a diffuser for diffusing a radiation source, the diffuser comprising a translucent body with a suction cup attachment end and a diffuser end, the suction cup end attaching the diffuser to the radiation source and the diffuser end diffusing radiation source radiation that travels through the translucent body into a plurality of directions. The diffuser can contain a diffusion element, which is colored and/or is made of a thermoplastic.

Preferably, the present invention also includes a diffuser for diffusing a radiation source, the diffuser comprising a translucent body with a suction cup attachment end and a diffuser end, the suction cup end positioning the diffuser in a path of radiation source radiation and the diffuser end diffusing the radiation source radiation that travels through the translucent body into a plurality of directions. The diffuser can contain a diffusion element, which is colored and/or is made of a thermoplastic.

The invention and its particular features and advantages will become more apparent form the following detailed description considered with reference to the accompanying drawings.

### BRIEF DESCRIPTION OF THE DRAWINGS

FIG. 1 is a cross sectional view of an embodiment of a light diffusing device in accordance with present invention; and

FIG. 2 is a cross sectional view of an alternative embodiment of the diffuser of the present invention.

### DETAILED DESCRIPTION OF THE DRAWINGS

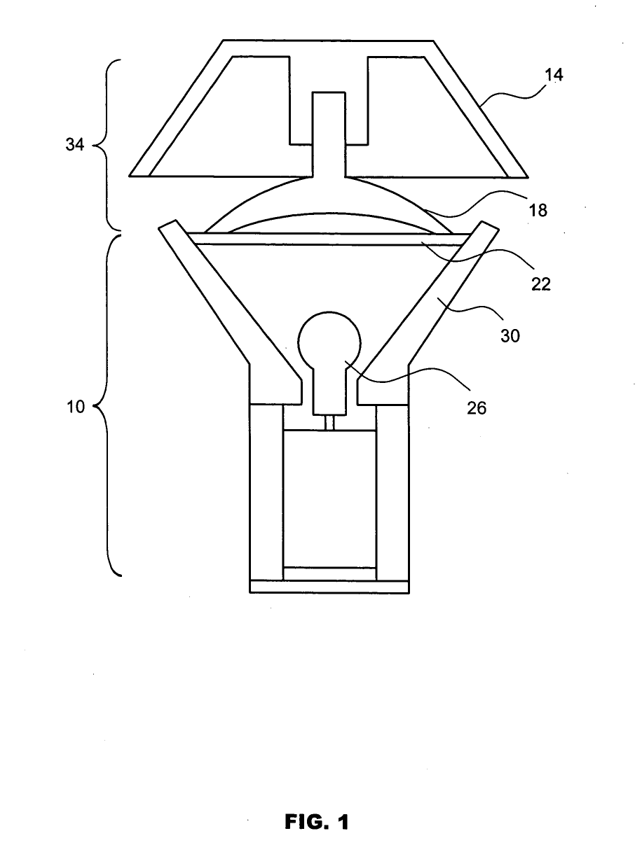

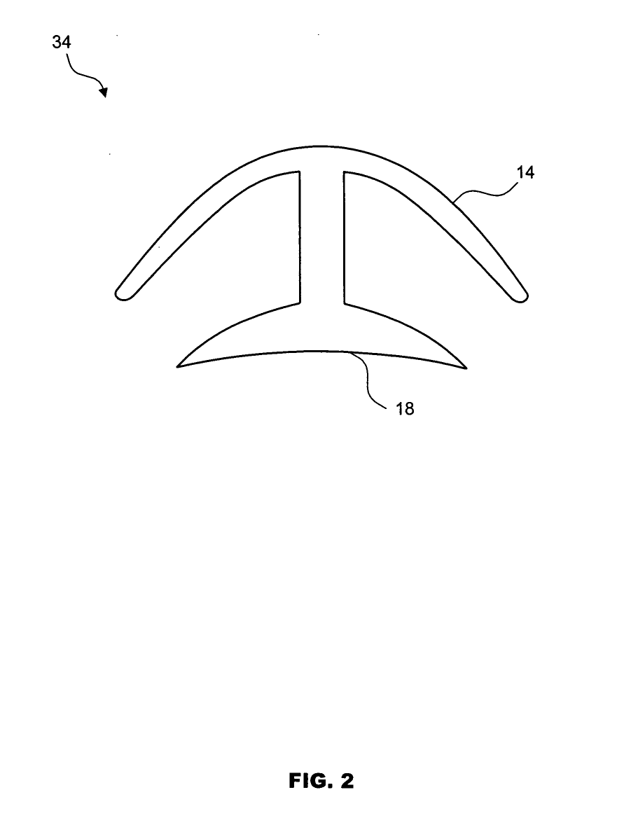

Referring to FIGS. 1 and 2, a light-diffusing device 34 for adapting a spotlight into a point light in accordance with present invention is shown. A spotlight is a point radiation source that emanates radiation in a predominately preferred direction that is defined by a conic volume in which a substantial portion of the radiation can fall such as light from a flashlight. A point light is a point radiation source in which the radiation emitted diverges multi-directionally or glows radially from the point radiation source.

Light diffusing device 34 has two ends. The first end is suction cup 18 and is used to semi-permanently or removably attach the light-diffusing device to a radiation source such as a flashlight, lamp, luminaire, radiation emitter or the like. A luminaire or light source 10 is a complete lighting unit consisting of a lamp 26 or lamps, parts to protect the lamp or lamps such as a housing 30 and/or medium 22, parts to distribute the light such as a reflector, medium 22 and/or baffle, and other accessories necessary and/or optional for the working of the lighting unit. A lamp 26 is a radiation source created to produce optical and near-optical radiation.

Light diffusing device 34 attachment can be made directly onto the radiation source such as lamp 26 or onto to medium 22 through which the radiation passes. In one embodiment the device 34 can be attached to the end of a flashlight from which light is emitted. In a preferred embodiment, the device 34 is attached to the clear cover or mechanism in a flashlight that protects the bulb. Regardless of where suction cup 18 is attached, radiation passes through suction cup 18 and travels to the second end of light diffusing device 34, which is diffusion element 14.

The radiation received through suction cup 18 also passes through diffusion element 14 thereby diffusing the radiation. In this diffusion process, the radiation of the spot light, which is predominately unidirectional within a conic volume, is altered into a multi-directional or radial glow thus turning a spotlight source of radiation and into a point light source of radiation. Consequently, the diffusion process produced by diffusion element 14 serves to change the direction of the spot light radiation into a plurality of alternative paths.

In one embodiment of the invention, diffusion element 14 is made of a different material than suction cup 18. FIG. 2 shows an alternative embodiment of the invention utilizing a light diffusing device 34 fabricated entirely out of one material. Still yet another embodiment of the invention has light diffusing device 34 fabricated out of a plurality materials. In a preferred embodiment, suction cup 18 is realized using a thermoplastic thereby enabling the device to withstand the heat and temperatures generated by a radiation source.

Diffusion element 14 can be fabricated from materials that would impart a color different than the color of the radiation traveling through suction cup 18. Accordingly, the radiation emanating from the aforementioned color inducing diffusion element 14 would possess a color different than the radiation that traveled through suction cup 18.

A preferred embodiment of the invention provides for diffusion element 14 to be interchangeable from suction cup 18 thereby providing a single base to which a plurality of colored diffusion elements 14 can be attached and received at different times. For example, a red diffusion element that emits red colored radiation and a green diffusion element that emits green colored radiation could be interchanged by mariners for use as fore and aft running lights. A variety of different colored diffusion elements could be used. An alternative embodiment would provide a diffusion element 14 that could produce a plurality of colors at one time. One embodiment of the invention also contemplates a kit having different colored diffusion elements that can be interchanged based on the color the user desires.

Also, there is a plurality of shapes for diffusion element 14 and the shape chosen is dependent on how the user wants the spot light reshaped into a point light. For instance, a section or sections of diffusion element 14 can have an applied reflective application thereby providing a greater focusing of the radiation in a given direction. For example, the top of diffusion element 14 being can covered by an application with a reflective surface facing suction cup 18 thus redirecting spot light radiation back towards and/or outside the spotlight radiation's normal emanation conic volume. Accordingly, various applications can be applied to diffusion element 14 to reshape the spotlight radiation's normal emanation conic volume into a radiation path that fulfills the users needs. The invention contemplates a kit having more than one diffusion element. Each diffusion element having a different shape for shaping the radiation in a different way.

One example of a luminaire is luminaire 10, which includes a housing 30 which positions medium 22 away from lamp 26. However, to those skilled in the art, any variety of light sources, lamps or luminaries could be used. In one embodiment, luminaire 10 can be distributed with light diffusing device 34 as an unattached kit that will produce light diffusing device assembly 38. In an alternative embodiment, light diffusing device 34 can be distributed by itself because of its adaptable design which provides a method to adapt almost any spot light radiation source into an point light radiation source.

Although the invention has been described with reference to a particular arrangement of parts, features and the like, these are not intended to exhaust all possible arrangements or features, and indeed many other modifications and variations will be ascertainable to those of skill in the art.

1. A light diffusing device assembly for attachment to a flashlight comprising:
a light source for emitting radiation, the light source having an emission section;
a translucent suction cup with a first side and a second side, the first side removably attached to the lamp emission section; and
a diffusion element attached to the second side of the translucent suction cup, the diffusion element radiating the lamp radiation out in a multi-directional direction.

2. The light diffusing device assembly of claim 1 wherein the diffusion element imparts at least one color to the radiation.

3. The light diffusing device assembly of claim 1 wherein the diffusion element is removably attached.

4. The light diffusing device assembly of claim 1 wherein the translucent suction cup is made of a thermoplastic.

5. The light diffusing device assembly of claim 1 further comprising a second diffusion element for shaping the emanation of the lamp radiation.

6. A light diffusing device that adapts spot light radiation into point light radiation, the light diffusing device comprising:
a light source for emitting radiation, the light source having an emission section and a connection section;
a housing with an emission end and a connection end inside the housing, the connection section of the light source connected to the connection end of the housing and the emission section of the lamp surrounded by the housing;
a medium through which the light source radiation passes, the medium having an exterior face and an edge, the edge attaching the medium to the emission end of the housing;
a translucent suction cup with a first side and a second side, the first side attached to the exterior face of the medium; and
a diffusion element attached to the second side of the translucent suction cup, the diffusion element radiating the light source radiation into a plurality of directions.

7. The light diffusing device of claim 6 wherein the diffusion element imparts at least one color to the radiation.

8. The light diffusing device of claim 6 wherein the diffusion element is removably attached.

9. The light diffusing device of claim 6 wherein wherein the translucent suction cup is made of a thermoplastic.

10. The light diffusing device of claim 6 further comprising a second diffusion element for shaping the emanation of the lamp radiation.

11. The light diffusing device of claim 6 further comprising a second diffusion element having a different color than said first diffusion element.

12. A spot light adaptor for use with a spot light radiation source, the spot light adaptor comprising:
a translucent suction cup with a first side and a second side, the first side selectively and removably attachable to the spot light radiation source; and
a diffusion element on the second side of the translucent suction cup, the diffusion element radiating the spot light radiation source out into a plurality of directions.

13. The spot light adaptor of claim 12 wherein the diffusion element imparts at least one color to the spot light radiation.

14. The spot light adaptor of claim 12 wherein the diffusion element is removably attached.

15. The spot light adaptor of claim 12 wherein the translucent suction cup is made of a thermoplastic.

16. The spot light adaptor of claim 12 further comprising a second diffusion element for shaping the emanation of the lamp radiation.

17. A diffuser for diffusing spot light radiation from a flashlight, the diffuser comprising a translucent body with a suction cup attachment end and a diffuser end, the suction cup attachment end attaching the diffuser to a radiation source and the diffuser end diffusing the radiation source radiation that travels through the translucent suction cup out into a plurality of directions.

18. The diffuser of claim 17 wherein the diffusion element imparts at least one color to the spot light radiation.

19. The diffuser of claim 17 wherein the diffusion element is removably attached to the suction cup attachment end.

20. The diffuser of claim 17 wherein the translucent suction cup is made of a thermoplastic.

21. The diffuser of claim 17 wherein the diffusion element comes in a plurality of shapes for shaping the emanation of the spot light radiation.

22. The diffuser of claim 17 wherein the translucent suction cup is made of a thermoplastic.

23. A diffuser for diffusing a spot light radiation source, the diffuser comprising a translucent body with a suction cup attachment end and a diffuser end, the suction cup end positioning the diffuser in the spot light radiation source's path and the diffuser end diffusing the radiation source radiation that travels through the translucent body into a plurality of directions.

24. The diffuser of claim 23 wherein the diffusion element imparts at least one color to the spot light radiation.

25. The diffuser of claim 23 wherein the diffusion element is removably attached to the suction cup attachment end.

26. The diffuser of claim 23 wherein the translucent suction cup is made of a thermoplastic.

27. The diffuser of claim 23 wherein the diffusion element comes in a plurality of shapes for shaping the emanation of the spot light radiation.

28. The diffuser of claim 23 wherein the translucent suction cup is made of a thermoplastic.
